(19) United States
(12) Patent Application Publication
(10) Pub. No.: US 2026/0311090 A1
(43) Pub. Date: Oct. 8, 2026

(54) Method and System for Workflow Builder Automation Using Workflow Definition Language

(71) Applicant: Ordr, Inc., Santa Clara, CA (US)

(72) Inventors: Sakthi Dasan Sekar, Chennai (IN); Gnanaprakasam Pandian, Cupertino, CA (US); Senthil Arunachalam, Fremont, CA (US); Gowri Sunder Ravi, Mountain View, CA (US); Pralay Kumar Das, Bangalore (IN)

(73) Assignee: Ordr, Inc., Santa Clara, CA (US)

(21) Appl. No.: 19/170,876

(22) Filed: Apr. 4, 2025

(51) Int. Cl. G06Q 10/0631; G06F 3/04842; G06F 3/04847; G06F 3/0486; H04L 9/40

(52) U.S. Cl. CPC G06Q 10/06316; G06F 3/04842; G06F 3/04847; G06F 3/0486; H04L 63/101

(57) ABSTRACT

Techniques for implementing workflow automation using a workflow definition language (WDL) as a bridge between a user interface in which a user visually designs an automated workflow and a backend execution of the automated workflow. One or more embodiments include a workflow builder tool that enables users to design and manage workflows using modular workflow components. Users can drag and drop the modular workflow components into a workspace of the workflow builder tool, thereby creating a workflow configuration that includes a sequence of workflow components. The system translates the workflow configuration into a WDL script. The WDL is a human-readable domain-specific language engineered to express complex workflows using a structured syntax for defining attributes of the workflow components. The system then causes execution of a computer-based process using the WDL script.

### TECHNICAL FIELD

The present disclosure relates to workflow automation. In particular, the present disclosure relates to workflow builder tools for automating workflows within a computer system.

### BACKGROUND

A workflow builder tool is a software application that allows users to visually design and create automated workflows within a system. A workflow is a series of activities configured to complete a task. Workflow automation shifts the performance of those activities from humans to a software program. Workflow builder tools enable users to map out a sequence of steps or tasks to complete a specific process.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for implementing workflow automation using a workflow definition language in accordance with one or more embodiments;

FIGS. 3-5 illustrate different stages of a graphical user interface (GUI) of a workflow builder tool in accordance with one or more embodiments; and

FIG. 6 is a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. SYSTEM ARCHITECTURE
3. WORKFLOW AUTOMATION USING A WORKFLOW DEFINITION LANGUAGE
4. EXAMPLE EMBODIMENTS
5. COMPUTER NETWORKS AND CLOUD NETWORKS
6. HARDWARE OVERVIEW
7. MISCELLANEOUS; EXTENSIONS

### 1. General Overview

One or more embodiments implement workflow automation using a workflow definition language (WDL) as a bridge between a user interface in which a user visually designs an automated workflow and a backend execution of the automated workflow. The system includes a workflow builder tool that enables users to design and manage workflows using modular workflow components. Users can drag and drop the modular workflow components into a workspace of the workflow builder tool, thereby creating a workflow configuration that includes a sequence of workflow components. The system translates the workflow configuration into a WDL script. The WDL is a human-readable domain-specific language engineered to express complex workflows using a structured syntax for defining attributes of the workflow components. The system then causes execution of a computer-based process using the WDL script. Typical workflow builder tools convert workflow components into executable code written in a general-purpose language or format that can be used across many application domains. By converting the workflow configuration into a WDL script instead of a script written in a general-purpose language or format, the system provides a scalable, extensible, and adaptable framework in which new workflow components can be added to and made available within the workflow builder tool without having to modify the core architecture of the backend execution.

Additionally, in some embodiments, the system provides a dedicated panel in the workflow builder tool that the user can interact with to input parameter values for the workflow components that are added to the workspace. As a result, the system provides the user with an efficient and convenient way to define the properties of workflow components and thus change the resulting generated WDL script. Furthermore, in one or more embodiments, the system monitors the workflow construction process and verifies that parameter values input for workflow components by users are valid. In an embodiment, the system provides real-time warnings or alerts for invalid or parameter configurations.

One or more embodiments described in this Specification and/or recited in the claims may not be included in this General Overview section.

Detailed examples are described below for purposes of clarity. Components and/or operations described below should be understood as one specific example that may not be applicable to certain embodiments. Accordingly, components and/or operations described below should not be construed as limiting the scope of any of the claims.

### 2. System Architecture

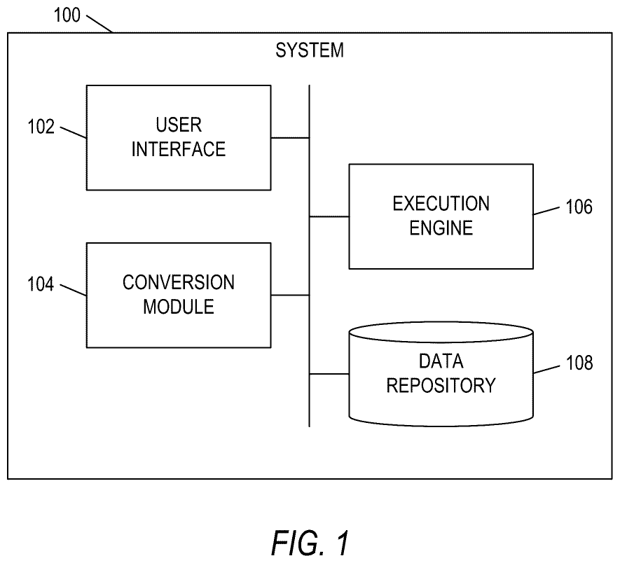

FIG. 1 illustrates a system 100 in accordance with one or more embodiments. As illustrated in FIG. 1, system 100 includes a user interface 102, a conversion module 104, an execution engine 106, and a data repository 108. In one or more embodiments, the system 100 may include more or fewer components than the components illustrated in FIG. 1. The components illustrated in FIG. 1 may be local to or remote from each other. The components illustrated in FIG. 1 may be communicatively coupled to each other via a direct connection or via a network. In some embodiments, the system 100 is communicatively coupled to a network. The components illustrated in FIG. 1 may be implemented in software and/or hardware. Each component may be distributed over multiple applications and/or machines. Multiple components may be combined into one application and/or machine. Operations described with respect to one component may instead be performed by another component.

In an embodiment, the components of the system 100 are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, the data repository 108 may be any type of storage unit and/or device (e.g., a file system, database, collection of tables, or any other storage mechanism) for storing data. Furthermore, the data repository 108 may include multiple different storage units and/or devices. The multiple different storage units and/or devices may or may not be of the same type or located at the same physical site.

In some embodiments, the system 100 is configured to implement and provide a workflow builder tool that enables users to design and manage workflows using modular workflow components. The workflow builder tool enables a user to build workflows, via a computing device of the user, by adding, removing, and connecting blocks or nodes that represent different steps or actions in a process or workflow. These blocks or nodes are also referred to as “workflow components.”

In one or more embodiments, the system 100 provides a Low-Code No-Code (LCNC) development platform that allows users to create application workflows with little to no coding. LCNC development platforms use visual interfaces and pre-built components to help users build applications. LCNC development platform may be configured to enable a user of a computing device to build a workflow by using a GUI of the LCNC development platform to drag and drop workflow components. Drag and drop is a UI interaction where a user selects an object displayed in a display area on a computing device and, using a pointing device (e.g., a mouse or finger), drags the object to a new location in the display area on the computing device. For example, a drag operation may begin when a user selects a draggable element, continue when the user drags the element to a droppable location, and then end when the user releases the dragged element, thereby resulting in a corresponding drag and drop event.

In some embodiments, the user interface 102 includes hardware and/or software configured to facilitate communications between a user and one or more components of the system 100. The user interface 102 renders user interface elements and receives input via user interface elements. Examples of user interface elements include checkboxes, radio buttons, dropdown lists, list boxes, buttons, toggles, text fields, date and time selectors, command lines, sliders, pages, and forms. The user interface 102 may render other content as well.

In one or more embodiments, the user interface 102 is configured to provide drag and drop functionality to a user of the system 100 and a detect drag and drop event corresponding to the user dragging and dropping a target workflow component into a workspace of a workflow builder tool provided by the system 100. The term “target” is used herein to identify the specific workflow component that the user is attempting to manipulate or otherwise affect via interaction with the workflow builder tool. The workspace of the workflow builder tool is the visual environment where the user designs and manages workflows, allowing the user to create, edit, and organize automated processes. The workspace may include a panel or some other section or component within a GUI of the workflow builder tool that is used to display and manage specific information or functionalities of the workflow builder tool. For example, the workspace may include a panel dedicated to the presentation of a workflow configuration that the user is configuring during the building of a workflow. The workflow configuration may comprise a plurality of workflow components that is arranged together to form a workflow.

In some embodiments, the user interface 102 is configured to detect a drag and drop event involving a target workflow component. For example, the user interface 102 may detect a drag and drop event corresponding to a user dragging and dropping a target workflow component into the workspace of the workflow builder tool. In an embodiment, the user interface 102 is configured to add the target workflow component to a workflow configuration displayed in the workspace in response to the detection of the drag and drop event.

In one or more embodiments, the user interface 102 is configured to enable a user to interact with the target workflow component and user interface elements to configure parameter values for parameters of the target workflow component. For example, the user interface 102 may cause a parameter of the target workflow component and a user interface element associated with the parameter to be displayed on a computing device of the user in response to the user selecting (e.g., clicking on, tapping on) the target workflow component displayed in the workspace. The user interface element may be configured to receive user input defining a parameter value for the parameter.

In some embodiments, the user interface 102 is configured to actively monitor the workflow construction process and provide real-time warnings or alerts for issues with the workflow configuration in the workspace. Examples of issues that may result in the presentation of warnings or alerts include, but are not limited to, missing parameter configurations (e.g., the user failed to input a parameter value for a parameter), an invalid parameter configuration (e.g., the user input an invalid parameter value for a parameter), an incomplete connection between workflow components (e.g., the user failed to connect a particular workflow component in the workspace to another particular workflow component), and an invalid connection between workflow components in the workspace (e.g., the user connected two workflow components that are incompatible with one another for the purposes of directly connecting them).

In some embodiments, the conversion module 104 includes a software component that is configured to convert the workflow configuration in the workspace into a WDL script. The WDL script is written in a human-readable domain-specific language, instead of in a general-purpose language or format. A domain-specific language is a computer language that is specialized to a particular application domain, which is in contrast to a general-purpose language that is broadly applicable across domains.

In one or more embodiments, the conversion module 104 uses a WDL that is designed to automate complex sequences of tasks within a Cyber Asset Attack Surface Management (CAASM) system. A CAASM system helps organizations identify and manage potential vulnerabilities in their assets, such as computing devices, hardware, cloud assets, and applications. The CAASM system may consolidate and normalize asset data. The asset data may include a corresponding identifier for each asset being managed as well as attributes (e.g., technical specifications) of the asset and other data (e.g., usage data) related to the asset. In an embodiment, the asset data is stored in the data repository 108 for subsequent use by the CAASM system. The system 100 may be running within or connected to a CAASM system.

The system 100 may be configured to use the WDL to provide core operational capabilities for workflow automation in CAASM systems. In some embodiments, the system 100 is configured to use the WDL to provide one or more of the following functions: asset attribute assignment, asset deletion, scan initiation, report generation, mail report scheduling, event-based alert configuration, policy enforcement, compliance validation, and data synchronization across systems. Asset attribute assignment includes automating the classification and tagging of assets with attributes such as profile, device name, custom tags, risk scores, ownership, or criticality level. Asset deletion includes defining workflows to safely and systematically remove outdated or decommissioned assets from the inventory. Scan initiation includes launching scans for asset discovery or vulnerability detection based on predefined workflows. Report generation includes automating the creation of detailed reports on asset statuses and vulnerabilities. Mail report scheduling includes configuring workflows to email reports to stakeholders on a recurring basis, ensuring timely dissemination of critical information. Event-based alert configuration includes setting up workflows to trigger alerts or tickets and escalate incidents to appropriate teams based on specific events, such as a detected vulnerability or compliance breach. Policy enforcement includes automating the application and enforcement of security policies across assets, ensuring consistency and reducing manual effort. Compliance validation includes defining workflows to verify asset configurations, ensuring alignment with industry or organizational compliance standards. Data synchronization across systems includes synchronizing asset data with third-party tools, such as Configuration Management Databases (CMDBs) or Security Information and Event Management (SIEM) systems. The system 100 may be configured to use the WDL to provide other functions as well.

The WDL used by the system 100 provides structured grammar to define workflows, capturing key operations such as data inputs, conditional logic, actions, enforcement rules, and scheduling. The WDL includes core components that reflect the logical flow of workflow automation. These core components may include an input component, a condition component, an action component, a schedule component, and an output component. The input component defines sources of data, enabling workflows to interact with external databases, APIs, or systems. The condition component represents logical decision-making constructs, allowing workflows to branch dynamically based on evaluated conditions. The action component specifies tasks triggered by workflow logic, such as sending alerts, applying updates, enforcing a policy or modifying records. The schedule component defines the timing and frequency of workflow execution, supporting one-time, periodic, or event-driven triggers. The output component captures the workflow's final results, such as logs, reports, or notifications, providing clear visibility into outcomes. These core components form a structured and flexible framework for defining, validating, and executing complex workflows.

In some embodiments, the conversion module 104 is configured to parse the workflow defined by the workflow configuration in the workspace and identify input parameters and actions to perform. The conversion module 104 may call the respective backend functions for actual execution. For example, the conversion module 104 may transmit the WDL script to the execution engine 106 for execution.

In one or more embodiments, the execution engine 106 includes a software component (e.g., a programmed module) that is configured to execute, trigger, or otherwise cause execution of a computer-based process using the WDL script. The execution engine 106 may be incorporated into or communicate with a CAASM system to cause execution of the computer-based process. In some embodiments, the execution engine 106 is configured to provide the necessary environment for executing code corresponding to the computer-based process, controlling execution of the code, and producing outcomes or results.

In some embodiments, the data repository 108 is configured to store details of the workflow configuration that the user has defined using the user interface 102. For example, the data repository 108 may store the workflow components that the user has added to the workspace, the connections that the user has established between the workflow components, and the parameter values that have been assigned to the parameters of the workflow components based on user input. The data repository 108 may also store the WDL script that the conversion module 104 has generated based on the workflow configuration designed by the user.

The system 100 uses the WDL to provide an innovative translation mechanism that converts intuitive, user-friendly visual workflows into a WDL script that is used to execute a computer-based process, thereby enabling seamless automation of complex tasks. The system 100 enables users to define workflows using a human-readable syntax of the WDL. This human-readable syntax of the WDL allows for input for a workflow to be obtained from diverse sources such as tables, assets, files, external APIs, or the output of other workflows. One example of a syntax that the system 100 may use for an input component is provided below.
input {
   type: “Table”;
   Query: “SELECT * From Assets WHERE Criticality=‘high’”;
}

In some embodiments, the system 100 reads the syntax of the workflow defined by the user and validates it against grammar rules. These grammar rules may be defined using formal grammar tools, such as ANTLR, BNF, or PEG. For the syntax example provided above, the grammar rule may ensure that every input block starts with a keyword input and include a type and a query, both followed by a string and ending with a semicolon. One example of this grammar rule is provided below.
input: ‘input’‘{’type ‘:’STRING‘;’ ‘query’‘:’STRING ‘;’‘}’;

In an embodiment, the system 100 is configured to parse the syntax of the workflow and generate the WDL script if the syntax of the workflow conforms to the grammar rules. For example, if the syntax of the workflow conforms to the grammar, then the system 100 may generate an Abstract Syntax Tree (AST) that can be consumed by the backend execution engine 106 for further processing. An AST is a tree representation of the syntactic structure of a program, used by compilers and other tools to understand and manipulate code. An AST abstracts away irrelevant details, focusing on the core structure of the code. One example of an AST for the example input component discussed above is provided below.

```
InputBlock [symbol]
  type: ″ Table ″ [symbol]
  Query: ″SELECT * FROM assets WHERE criticality = ‘High’”
```

The use of the WDL by the system 100 provides several benefits. First, the WDL provides modularity, such that workflow components such as the input component, the condition component, and the action component can be reused across different workflows. Second, the WDL provides extensibility, such that users can define custom rules, actions, or triggers tailored to specific needs. Third, the WDL provides readability, as it is designed to be intuitive for users while remaining machine-parseable, thereby simplifying comprehension and debugging. Fourth, the WDL provides validation, ensuring that workflows are robust and error-free through rigorous grammar validation. Fifth, the WDL simplifies automation of complex tasks (e.g., CAASM tasks), such as enforcing compliance policies. Sixth, the WDL provides scalability, adapting to workflows of varying complexity and integrating seamlessly with external systems.

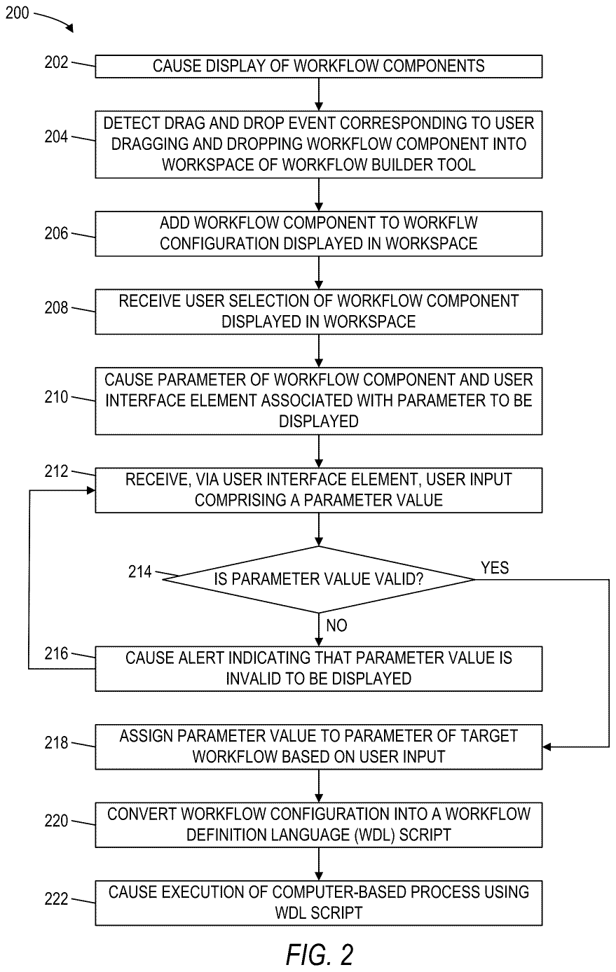

In one or more embodiments, the system 100 refers to hardware and/or software configured to perform operations described herein for implementing intelligent querying of network-connected devices. Examples of operations for implementing intelligent querying of network-connected devices, as well as further details of the features and functions of the system 100, are described below with reference to FIGS. 2, 3, 4, and 5.

### 3. Workflow Automation Using a WDL

FIG. 2 illustrates an example set of operations 200 for implementing workflow automation using a WDL in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

In an embodiment, the system 100 causes a plurality of pre-built workflow components to be displayed on a computing device of a user (Operation 202). The plurality of pre-built workflow components is displayed within a user interface of a workflow builder tool. The plurality of pre-built workflow components include, respectively, one or more corresponding parameters. For example, the plurality of pre-built workflow components may include an input component that has one or more corresponding parameters, a condition component that has one or more parameters that define conditions or rules to determine whether subsequent actions should be executed, an action component that has one or more corresponding parameters, a merge component that combines multiple inputs into a single stream or dataset for further processing, a split component that divides a dataset or input into smaller subsets for parallel or sequential processing, a wait component that pauses the workflow for a specified duration or until an external event occurs, a schedule component that has one or more corresponding parameters for scheduling an action to execute at a specific time or after a delay, a filter component that filters data or records based on specified criteria before passing it to the next workflow component, a transform component that applies transformations to input data (e.g., changing formats or deriving new fields), a notification component that sends notifications about workflow events or results, and an output component that has one or more corresponding parameters. The pre-built workflow components are configured to be dragged and dropped by the user into a workspace of the workflow builder tool.

In some embodiments, the input component includes a plurality of input functions from which the user can select in configuring the input component. The input functions are designed to handle different input sources or methods, making the workflow versatile and adaptable to various scenarios. For example, the plurality of input functions may include reading input from a table, reading input from a file, extracting input from a log file, fetching input from an API, reading input from a message queue, and importing input from an external workflow. Other types of input functions are also within the scope of the present disclosure.

In some embodiments, the plurality of pre-built workflow components include one or more of the following action components: a change virtual local area network (VLAN) component, an asset deletion component, an update asset tag component, a shutdown port component, a block IP address component, an enforce access control list (ACL) component, a disable user account component, a disable device component, an enforce password policy component, a restrict external communication component, an apply patch updates component, an isolate device component, an enable logging component, a revoke certificate component, a deploy security agent component, an adjust bandwidth allocation component, and an enforce device hardening policies component. Other types of action components are also within the scope of the present disclosure.

The change VLAN component is configured to reassign a device to a different VLAN for enhanced network segmentation or security. The asset deletion component is configured to permanently removes an asset from the inventory or database, ensuring it is no longer part of the attack surface or compliance scope. The update asset tag component is configured to modify or add tags to an asset to reflect updated classifications, ownership, or operational status. The shutdown port component is configured to disable a specific network port to prevent unauthorized access or contain a threat. The block IP address component is configured to add an IP address to a blocklist to prevent communication with malicious sources.

The enforce ACL component is configured to apply or update an ACL to control access to Critical Systems. The disable user account component is configured to temporarily or permanently disable a user account to prevent access during security investigations or after role termination. The disable device component is configured to isolate or deactivate a device from the network to mitigate threats, contain malware, or comply with security policies. The enforce password policy component is configured to apply or update password rules, such as complexity requirements or expiration settings. The restrict external communication component is configured to block a device or group of devices from communicating outside the internal network.

The apply patch updates component is configured to deploy security patches to vulnerable systems to mitigate known risks. The isolate device component is configured to move a device to a quarantine network for further investigation after detecting suspicious activity. The enable logging component is configured to activate detailed logging on a device to monitor activity for compliance or forensic purposes. The revoke certificate component is configured to revoke digital certificates associated with compromised devices or applications. The deploy security agent component is configured to install or update security agents on devices to enhance endpoint protection. The adjust bandwidth allocation component is configured to reconfigure bandwidth limits for specific devices or applications to prioritize critical resources. The enforce device hardening policies component is configured to apply security hardening configurations such as disabling unused ports or services.

In one or more embodiments, the system 100 detects a drag and drop event corresponding to the user dragging and dropping a target workflow component from the pre-built workflow components into the workspace of the workflow builder tool (Operation 204). For example, a drag operation may begin when the user selects the target workflow component from the pre-built workflow components, continue when the user drags the target workflow component to a droppable location within the workspace, and then end when the user releases the dragged target workflow component. As a result of the user dragging and dropping the target workflow component, a corresponding drag and drop event is fired, which is detected by the system 100.

In some embodiments, the system 100 adds the target workflow component to a workflow configuration displayed in the workspace in response to the detection of the drag and drop event (Operation 206). Prior to the addition of the target workflow component to the workspace, the workflow configuration may have included one or more workflow components previously added to the workspace by drag and drop operations performed by the user or as a default configuration by the system 100 based on user input provided by the user. Subsequent to the addition of the target workflow component, the workflow configuration may include a plurality of workflow components, including the target workflow component.

When the target workflow component is added to the workflow configuration in the workspace, the user may attempt to connect the target workflow component to another workflow component in the workflow configuration. In one or more embodiments, the system 100 verifies if the attempted connection is valid. For example, the system 100 may determine if the component type of the target workflow component is compatible with the component type of the other workflow component with which the user is attempting to connect the target workflow component. If the system 100 determines that the component type of the target workflow component is not compatible with the component type of the other workflow component, or that the attempted connection is otherwise invalid, then the system 100 may cause an alert to be displayed on the computing device of the user. The alert may include a warning or notification that indicates that the attempted connection is invalid and the reason for this determination of invalidity.

In an embodiment, the system 100 receives a user selection of the target workflow component displayed in the workspace (Operation 208). For example, the user may click or tap on the target workflow component. This user selection may be detected by the system 100.

In one or more embodiments, the system 100 causes a parameter of the target workflow component and a user interface element associated with the parameter to be displayed in response to receiving the user selection of the target workflow component (Operation 210). The parameter is a variable that used by the function of the target workflow component. For example, the target workflow component may be an input component that has a parameter for defining a query to be used for inputting data. In an embodiment, the user interface element associated with the parameter is configured to enable the user to define a parameter value for the parameter. For example, the user interface element may include a text field via which the user may enter a parameter value that defines the query to be used for inputting data. Other types of user interface elements are also within the scope of the present disclosure.

In some embodiments, the system 100 receives, via the user interface element associated with the parameter, user input that includes a parameter value (Operation 212). A parameter value is the actual data that is passed into the corresponding parameter when the function of the target workflow component is called. For example, the parameter value may include a specific query to be used for inputting data. Other types of parameter values are also within the scope of the present disclosure.

In an embodiment, the system 100 determines if the parameter value is valid for the parameter of the target workflow component (Operation 214). The system 100 may determine the validity of the parameter value for the parameter of the target workflow component in a variety of ways. In one example, the system 100 determines the validity of the parameter value by determining if the parameter value satisfies a set of one or more validation rules. Examples of validation rules include, but are not limited to, data type validation rules, range validation rules, format validation rules, and required field validation rules. Data type validation rules ensure that a field contains the correct type of data. Range validation rules verify that a value falls within a specified range. Format validation rules ensure that data conforms to a specific format. Required field validation rules ensure that a field is not left empty. Other types of validation rules are also within the scope of the present disclosure. In some embodiments, the system 100 inputs the parameter value into a model that is configured to determine if the parameter value is valid for the parameter and the model outputs a result indicating if the parameter value is valid or not.

In one or more embodiments, if the system 100 determines that the parameter value is invalid, then the system 100 causes an alert to be displayed on the computing device of the user (Operation 216). The alert indicates that the parameter is invalid. In an embodiment, the alert indicates a reason for the parameter being invalid. For example, the alert may include an identification or explanation of a validation rule that has been violated by the parameter value. The user may then correct the violation or otherwise address the invalidity of the parameter value, such as by using the corresponding user interface element again to modify the parameter value. The system 100 may then receive, via the user interface element, another user input including a new parameter value for the parameter (Operation 212) and determine if the new parameter value if valid (Operation 214).

In some embodiments, if the system 100 determines that the parameter value is valid, then the system 100 assigns the parameter value to the parameter of the target workflow component based on the user input (Operation 218). For example, the system 100 may store, in the data repository 108, the parameter value in association with the parameter of the target workflow component. The system 100 may then access the parameter value for the parameter of the target workflow component when performing subsequent operations.

In an embodiment, the system 100 converts the workflow configuration into a WDL script (Operation 220). The WDL script is written in a human-readable domain-specific language. The system 100 may convert the workflow configuration in the WDL script by parsing the workflow configuration, identifying input parameters and actions to perform, and generating the WDL script based on the identified input parameters and actions. In some embodiments, the system 100 generates an AST based on the workflow configuration in the workspace. However, the system 100 may generate the WDL script in other ways and formats as well.

In one or more embodiments, the system 100 causes execution of a computer-based process using the WDL script (Operation 222). The system 100 may cause the execution of the computer-based process by transmitting the WDL script to a backend execution engine. In some embodiments, the system 100 calls the respective backend functions that correspond to the elements of WDL script for actual execution.

### 4. Example Embodiments

Detailed examples are described below for purposes of clarity. Components and/or operations described below should be understood as one specific example that may not be applicable to certain embodiments. Accordingly, components and/or operations described below should not be construed as limiting the scope of any of the claims.

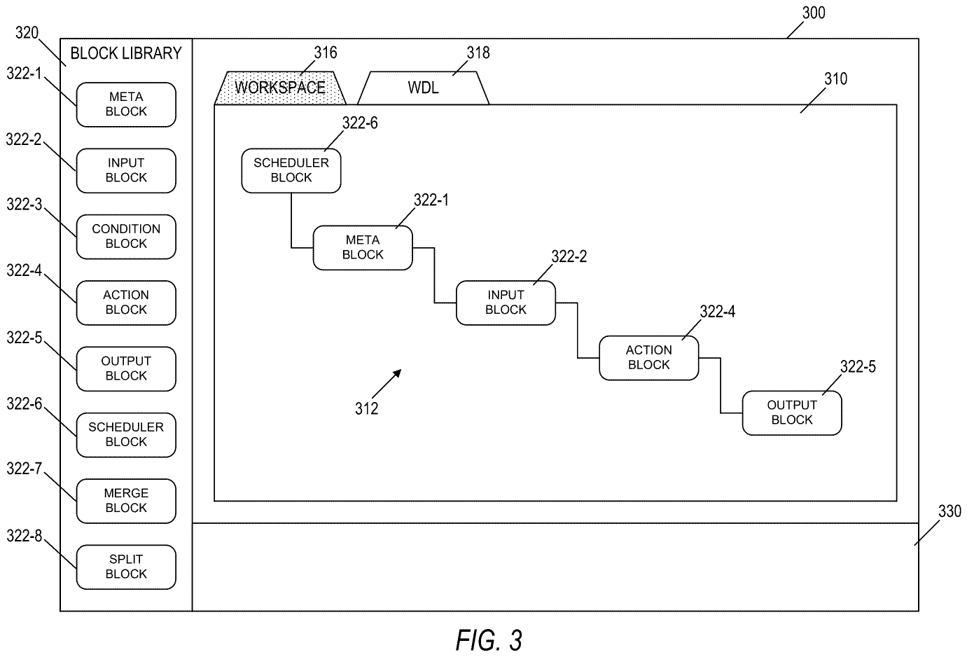

FIGS. 3-5 illustrate different stages of a GUI 300 of a workflow builder tool in accordance with one or more embodiments. The GUI 300 is designed to simplify workflow creation while ensuring accuracy and seamless backend execution. As shown in FIG. 3, the GUI 300 provides a dedicated workspace 310 in which users can visually design workflows by dragging and dropping modular workflow components 322, represented as blocks. In FIG. 3, the workflow components 320 are displayed in a dedicated panel 320. The workflow components 322 include a metadata block 322-1, an input block 322-2, a condition block 322-3, an action block 322-4, an output block 322-5, a scheduler block 322-6, a merge block 322-7, and a split block 322-8. Other workflow components 322 may also be provided in the dedicated panel 320.

In FIG. 3, the user has dragged and dropped workflow components 322-1, 322-2, 322-4, 322-5, and 322-6 to the workspace 310 and connected them to form a workflow 312. In some embodiments, the workflow components 322 are preconfigured with corresponding metadata that determines the type and purpose of the particular workflow components 322 within the workflow 312. For example, the input block 322-2 captures data sources and queries, the condition block 322-3 represents logical decision-making points, and the action block 322-4 triggers specific operations (e.g., sending notifications or applying policies). The workflow components 322 are equipped with input and output lines, allowing users to establish connections between workflow components 322 to represent logical workflows. These connections define the upstream and downstream relationships between operations. In some embodiments, the workflow components 322 are predefined with rules governing valid connections. For example, certain workflow components 322, such as the condition block 322-3, must be connected to compatible types, such as the action block 322-4. As another example, some workflow components 322, such as the output block 322-4, may not function independently and must be associated with other workflow components 322.

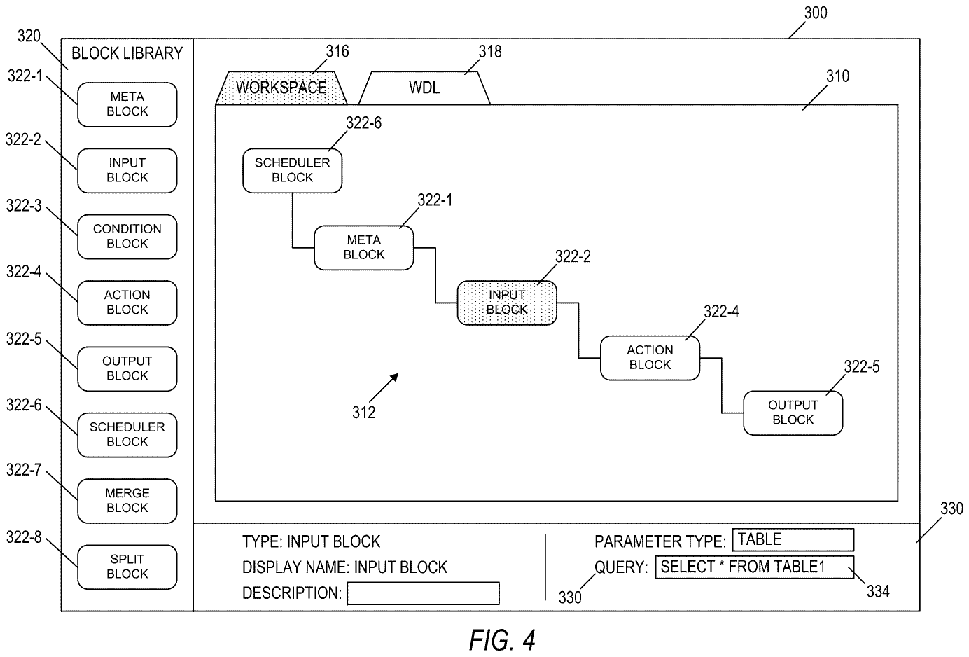

In one or more embodiments, the workflow components 322 are designed with parameters relevant to their type. For example, the input block 322-2 requires source and query parameters, the condition block 322-3 requires a logical expression, and the action block 322-4 may include parameters such as a function name and specific values for execution. In some embodiments, the GUI 300 is configured to enable users to configure these parameters via intuitive input fields within the GUI 300, ensuring workflows are tailored to specific tasks. For example, the GUI 300 may include a dedicated panel 330 for displaying the corresponding parameters of a particular workflow component 322 that has been selected from the workspace 310 by the user. In FIG. 4, the user has selected the input block 322-2 from the workspace 310, thereby resulting in the GUI 300 displaying parameters of the input block 322-2 within the panel 330. The corresponding parameter value of one or more of the parameters of the selected workflow component 322 may be configured by the user via a corresponding user interface element. For example, in FIG. 4, the user may define a parameter value for the “Query” parameter 330 using a text field 334 displayed in association with the “Query” parameter.

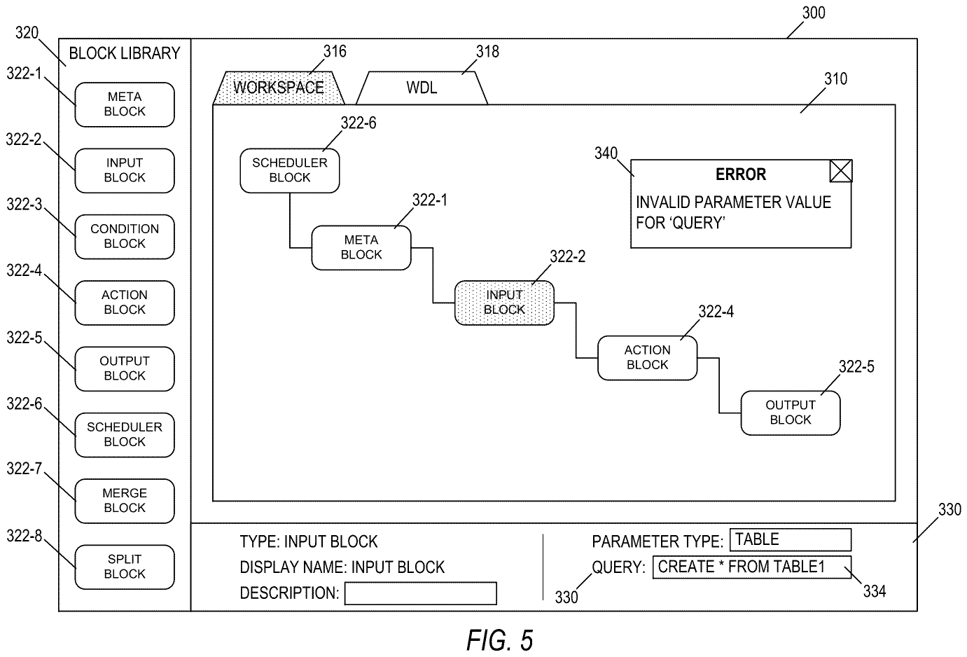

In some embodiments, the system 100 actively monitors the workflow construction process occurring within the workspace 310. The system 100 may provides real-time warnings or alerts via the GUI 300 for issues such as invalid or missing parameter configurations and incompatible or incomplete block connections. For example, in FIG. 5, the user has input an invalid parameter value for the “Query” parameter, thereby triggering the GUI 300 to display an alert 340 that indicates that the user has entered an invalid parameter value for the “Query” parameter.

The system 100 may perform a variety of different checks in real time while the user is building the workflow 312 within the workspace 310. These check may include, but are not limited to, a mandatory configuration check that ensures that all mandatory configuration fields in a block are filled before allowing workflow execution, a data type validation that ensures that the data types of inputs match the expected types (e.g., string, integer, list), a dependency validation that validates that dependent blocks have been configured correctly before allowing execution. (e.g., “Trigger Vulnerability Scan” action should not proceed unless a valid “Asset Selection” block is configured), an output-input compatibility validation that validates that the output of one block is compatible with the input of the connected block, a sequence order validation that ensures logical sequencing of blocks, where certain actions must follow specific prerequisites, a duplicate block validation that prevents the same block type from being used redundantly in a sequence unless explicitly allowed, and a workflow continuity check that ensures that all branches or paths in the workflow 312 terminate properly without dangling connections. Other types of check may be performed as well.

In one or more embodiments, the system 100 performs real-time WDL script generation. For example, as the user drags workflow components 322 into the workspace 310, connects them, and configures parameters, the system 100 dynamically translates the visual workflow 312 into a structured WDL script in the background, thereby ensuring that the design of the workflow 312 and its WDL representation remain synchronized. Once the workflow design is completed, the GUI 300 provides the user with a comprehensive view of the workflow 312, showing all connected blocks, their parameters, and the logical flow. The completed WDL script is ready to be consumed by a backend execution engine for parsing, validation, and execution, thereby ensuring that the workflow 312 is implemented as designed, with no loss of logic or detail. The GUI 300 may display selectable user interface elements configured to enable the user to trigger a display of the workflow 312 or a display of the corresponding WDL script. For example, in FIGS. 3-5, the GUI 300 displays a selectable tab 316 that the user may select to trigger a display of the workflow 312 and a selectable tab 318 that the user may select to trigger a display of the corresponding WDL script.

The system 100 disclosed herein may be used in a variety of different practical applications within the CAASM domain, addressing real-world challenges like asset management, vulnerability response, and network security. One practical application is to dynamically quarantine suspicious devices. For example, when a device shows unusual behavior, such as sending unexpected traffic patterns or connecting to known malicious IP addresses, the following workflow may be triggered: (a) monitor traffic using a network monitoring tool; (b) if suspicious behavior is detected, move the device to a quarantine VLAN; (c) automatically run a vulnerability scan and notify the security team; and (d) release quarantine if no vulnerabilities or threats are found within 24 hours.

Another practical application is to monitor airport devices for vulnerabilities. For example, devices in an airport network may be regularly scanned for vulnerabilities to protect sensitive passenger data using the following workflow: (a) schedule periodic scans for devices connected to airport networks; (b) flag devices with critical vulnerabilities; and (c) automatically isolate flagged devices from sensitive systems until patched.

Yet another practical application is to block unauthorized device communication. In this example, a newly discovered device starts communicating on the network without proper authorization. The following workflow may be used: (a) detect the new device using an asset discovery tool; (b) check its MAC address and IP against the authorized devices list; and (c) if unauthorized, block the device at the firewall or switch to prevent further traffic.

Yet another practical application is to provide automated compliance check for critical assets. For example, in order to ensure that all critical assets meet compliance requirements, such as updated antivirus, encryption, and secure configurations, the following workflow may be executed: (a) identify all critical assets tagged in the inventory; (b) check the configurations of the identified critical assets against predefined compliance rules; and (c) automatically apply fixes or notify the admin if non-compliance is detected.

Yet another practical application is to provide vulnerability-based traffic restriction. For example, when a critical vulnerability is discovered in a widely used software application and some devices remain unpatched, the following workflow may be executed: (a) identify devices with the vulnerable software version; (b) identify block outbound traffic from those devices to reduce exposure; and (c) automatically apply the patch once available and lift the restriction.

Yet another practical application is to secure onboarding of Internet of Things (IoT) devices. For example, when IoT devices are introduced to the network and their security needs to be verified before granting access, the following workflow may be executed: (a) place newly onboarded IoT devices in a restricted VLAN; (b) automatically verify firmware versions and configuration settings; and (c) if compliant, move the device to the appropriate operational VLAN.

Yet another practical application is to provide automated decommissioning workflow for legacy devices. For example, in order to securely remove legacy devices reaching end-of-life from a network, the following workflow may be executed: (a) identify devices marked as “end-of-life” in the inventory; (b) notify (e.g., e-mail) stakeholders about the decommissioning plan; and (c) securely wipe device data and remove the device from the network.

### 5. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 6. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

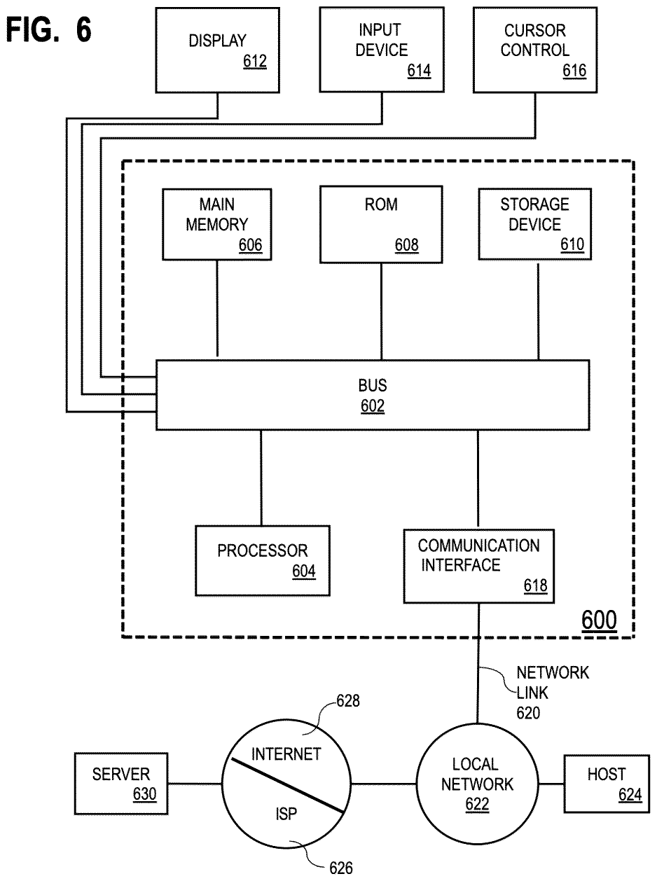

For example, FIG. 6 is a block diagram that illustrates a computer system 600 upon which an embodiment of the disclosure may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or a Solid State Drive (SSD) is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 7. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, causes performance of operations comprising:
detecting a drag and drop event corresponding to a user dragging and dropping a target workflow component into a workspace of a workflow builder tool;
responsive to detecting the drag and drop event, adding the target workflow component to a workflow configuration displayed in the workspace, the workflow configuration comprising a plurality of workflow components including the target workflow component;
converting the workflow configuration into a workflow definition language (WDL) script, the WDL script written in a human-readable domain-specific language; and
causing execution of a computer-based process using the WDL script.

2. The media of claim 1, wherein the WDL script defines attributes of the plurality of workflow components of the workflow configuration.

3. The media of claim 1, wherein the operations further comprise:
receiving a user selection of the target workflow component displayed in the workspace;
responsive to receiving the user selection of the target workflow component, causing a parameter of the target workflow component and a user interface element associated with the parameter to be displayed;
receiving, via the user interface element, user input comprising a parameter value; and
assigning the parameter value to the parameter of the target workflow component based on the user input.

4. The media of claim 1, wherein the operations further comprise:
receiving a user selection of the target workflow component displayed in the workspace;
responsive to receiving the user selection of the target workflow component, causing a parameter of the target workflow component and a user interface element associated with the parameter to be displayed;
receiving, via the user interface element, user input comprising a parameter value;
determining that the parameter value is invalid for the parameter of the target workflow component; and
responsive to determining that the parameter value is invalid, causing an alert to be displayed, the alert indicating that the parameter value is invalid.

5. The media of claim 1, wherein the operations further comprise:
causing a plurality of pre-built workflow components including the target workflow component to be displayed, the plurality of pre-built workflow components comprising, respectively, one or more corresponding parameters;
wherein the user drags and drops the target workflow component from the plurality of pre-built workflow components into the workspace of the workflow builder tool.

6. The media of claim 1, wherein the target workflow component comprises a pre-built action component corresponding to a Cyber Asset Attack Surface Management (CAASM) action, the CAASM action comprising:
an asset deletion action that permanently removes an asset from a data repository;
a change virtual local area network (VLAN) action that reassigns a device to a different VLAN;
a shutdown port action that disables a specific network port;
a block Internet Protocol (IP) address action that adds an IP address to a blocklist;
an access control list enforcement action that applies or updates an access control list to control access to a system or a network resource;
a restrict external communication action that blocks a device or a group of devices from communicating outside of an internal network;
an update asset tag action that modifies or adds one or more tags to an asset to indicate an updated classification of the asset, an updated ownership of the asset, or an updated operational status of the asset;
a disable user action that disables a user account; or
a disable device action that isolates or deactivates a device from a network.

7. The media of claim 1, wherein the target workflow component comprises a pre-built input component corresponding to:
reading input from a table;
reading input from a file;
extracting input from a log file;
fetching input from an application programming interface (API);
reading input from a message queue; or
importing input from an external workflow.

8. The media of claim 1, wherein the causing of the execution of the computer-based process using the WDL script comprises:
parsing the WDL script;
based on the parsing of the WDL script, translating the WDL script into an instruction for a server to execute one or more backend functions; and
submitting the instruction to the server.

9. A method performed by at least one device including a hardware processor, the method comprising:
detecting a drag and drop event corresponding to a user dragging and dropping a target workflow component into a workspace of a workflow builder tool;
responsive to detecting the drag and drop event, adding the target workflow component to a workflow configuration displayed in the workspace, the workflow configuration comprising a plurality of workflow components including the target workflow component;
converting the workflow configuration into a workflow definition language (WDL) script, the WDL script written in a human-readable domain-specific language; and
causing execution of a computer-based process using the WDL script.

10. The method of claim 9, wherein the WDL script defines attributes of the plurality of workflow components of the workflow configuration.

11. The method of claim 9, further comprising:
receiving a user selection of the target workflow component displayed in the workspace;
responsive to receiving the user selection of the target workflow component, causing a parameter of the target workflow component and a user interface element associated with the parameter to be displayed;
receiving, via the user interface element, user input comprising a parameter value; and
assigning the parameter value to the parameter of the target workflow component based on the user input.

12. The method of claim 9, wherein the operations further comprise:
receiving a user selection of the target workflow component displayed in the workspace;
responsive to receiving the user selection of the target workflow component, causing a parameter of the target workflow component and a user interface element associated with the parameter to be displayed;
receiving, via the user interface element, user input comprising a parameter value;
determining that the parameter value is invalid for the parameter of the target workflow component; and
responsive to determining that the parameter value is invalid, causing an alert to be displayed, the alert indicating that the parameter value is invalid.

13. The method of claim 9, further comprising:
causing a plurality of pre-built workflow components including the target workflow component to be displayed, the plurality of pre-built workflow components comprising, respectively, one or more corresponding parameters;
wherein the user drags and drops the target workflow component from the plurality of pre-built workflow components into the workspace of the workflow builder tool.

14. The method of claim 9, wherein the target workflow component comprises a pre-built action component corresponding to a Cyber Asset Attack Surface Management (CAASM) action, the CAASM action comprising:
an asset deletion action that permanently removes an asset from a data repository;
a change virtual local area network (VLAN) action that reassigns a device to a different VLAN;
a shutdown port action that disables a specific network port;
a block Internet Protocol (IP) address action that adds an IP address to a blocklist;
an access control list enforcement action that applies or updates an access control list to control access to a system or a network resource;
a restrict external communication action that blocks a device or a group of devices from communicating outside of an internal network;
an update asset tag action that modifies or adds one or more tags to an asset to indicate an updated classification of the asset, an updated ownership of the asset, or an updated operational status of the asset;
a disable user action that disables a user account; or
a disable device action that isolates or deactivates a device from a network.

15. The method of claim 9, wherein the target workflow component comprises a pre-built input component corresponding to:
reading input from a table;
reading input from a file;
extracting input from a log file;
fetching input from an application programming interface (API);
reading input from a message queue; or importing input from an external workflow.

16. The method of claim 9, wherein the causing of the execution of the computer-based process using the WDL script comprises:
parsing the WDL script;
based on the parsing of the WDL script, translating the WDL script into an instruction for a server to execute one or more backend functions; and
submitting the instruction to the server.

17. A system comprising:
at least one device including a hardware processor;
the system being configured to perform operations comprising:
detecting a drag and drop event corresponding to a user dragging and dropping a target workflow component into a workspace of a workflow builder tool;
responsive to detecting the drag and drop event, adding the target workflow component to a workflow configuration displayed in the workspace, the workflow configuration comprising a plurality of workflow components including the target workflow component;
converting the workflow configuration into a workflow definition language (WDL) script, the WDL script written in a human-readable domain-specific language; and
causing execution of a computer-based process using the WDL script.

18. The system of claim 17, wherein the operations further comprise:
receiving a user selection of the target workflow component displayed in the workspace;
responsive to receiving the user selection of the target workflow component, causing a parameter of the target workflow component and a user interface element associated with the parameter to be displayed;
receiving, via the user interface element, user input comprising a parameter value; and
assigning the parameter value to the parameter of the target workflow component based on the user input.

19. The system of claim 17, wherein the operations further comprise:
receiving a user selection of the target workflow component displayed in the workspace;
responsive to receiving the user selection of the target workflow component, causing a parameter of the target workflow component and a user interface element associated with the parameter to be displayed;
receiving, via the user interface element, user input comprising a parameter value;
determining that the parameter value is invalid for the parameter of the target workflow component; and
responsive to determining that the parameter value is invalid, causing an alert to be displayed, the alert indicating that the parameter value is invalid.

20. The system of claim 17, wherein the operations further comprise:
causing a plurality of pre-built workflow components including the target workflow component to be displayed, the plurality of pre-built workflow components comprising, respectively, one or more corresponding parameters;
wherein the user drags and drops the target workflow component from the plurality of pre-built workflow components into the workspace of the workflow builder tool.
